(19) United States
(12) Patent Application Publication
(10) Pub. No.: US 2013/0133536 A1
(43) Pub. Date: May 30, 2013

(54) STAMPING APPARATUS

(71) Applicant: Terrence William Bolton, Redhill (GB)

(72) Inventor: Terrence William Bolton, Redhill (GB)

(73) Assignee: LAJA MATERIALS LIMITED, Isle of Man (GB)

(21) Appl. No.: 13/703,145

(22) PCT Filed: Jun. 9, 2011
(86) PCT No.: PCT/GB2011/000877

§ 371 Date: Feb. 14, 2013

(30) Foreign Application Priority Data
Jun. 9, 2010 (GB) 1009621.2

(51) Int. Cl. B41K 1/34; B41K 1/42

(52) U.S. Cl. CPC B41K 1/34
USPC 101/333

(57) ABSTRACT

A stamp for transferring a personalised coloured image onto a selected surface includes a stamping block with a lower surface and a flexible image bearing impermeable substrate of a polymer or copolymer having a textured surface. The stamp may be hand held and may include a handle at its end remote from the stamping surface of the substrate. The substrate may be separable from and attachable to the front surface of the stamping block. One or a plurality of flexible image bearing impermeable substrates may be provided. The substrate material is preferably ethylene vinyl acetate.

This invention relates to stamping apparatus for transferring personalised and other coloured images onto a selected surface. More especially, the invention relates to hand held stamping apparatus for transferring personalised and other coloured images onto a selected surface.

Hand held stamps generally include an image containing stamping surface of rubber or like material which is wetted through contact with an ink pad. The ink may permeate into the stamping surface which remains wet for a limited amount of time.

Hand held stamps for transferring an inked image to a sheet of paper or some other medium are well known. Examples of such stamps are to be found in US2005/139103A1, JP07186504A, JP06024114A and JP2000052630A.

The image transferred by any given known stamp is generally fixed which means that a multiplicity of different stamps is required for use to convey different images. Stamps which enable the image to be varied within set limitations are known, such as date stamps.

To the best of the Applicant's knowledge, however, no stamps have previously been proposed by which the user can create his or her personalised image for transfer to, for example, a sheet of drawing paper. Such a stamp is likely to be especially appealing to children but only if it is relatively simple and clean to use and is capable of giving free range to the child's ability to create coloured images for transfer to a sheet of paper or the like.

It is an object of this invention to provide such a stamp.

In one aspect the invention comprises stamping apparatus for transferring a personalised or other coloured image onto a selected surface, the apparatus comprising a stamp including a stamping block on which is attached a flexible impermeable substrate of a polymer or copolymer onto which personalised images can be transcribed by a user.

Preferably, the substrate has a textured surface.

The substrate may be separable from but attachable to the stamping block. Alternatively, the substrate may be permanently attached to the stamping block.

The stamp may be hand held and may include a handle at its end remote from the stamping surface of the substrate. The stamping surface typically comprises an exposed surface of a substrate positioned at the end of the stamp remote from the handle.

In another aspect the invention provides a colouring set comprising a stamp including a stamping block, a flexible image bearing impermeable substrate of a polymer or copolymer for selective or permanent attachment to a front surface of the stamping block, the susbtrate being formed with a textured surface, and a source for applying liquid colorant onto the textured surface of the substrate.

Preferably the stamp is hand held. A handle for the stamp may be provided. Alternatively, the stamp may be shaped to enable it to be gripped when it is applied to an image receiving surface.

In a further arrangement the stamp comprises a shaped body which may include a removable lid to enable the body to retain substrates not in use.

In an alternative arrangement the stamp comprises a ring to be worn on a digit of the user, the ring having a stamping block with a surface to which is permanently or removably attached a substrate having an image receiving surface as described above.

Preferably the substrate comprises ethylene vinyl acetate (EVA).

The substrate may comprise a flat sheet in the shape of a rectangle, square, circle, ellipse or other regular or irregular shape. Also, the substrate may be one of a set of such substrates of the same or different shapes. The set may comprise a plurality of individual substrates or, for example, a sheet holding a plurality of substrates each removable from the sheet through perforations or the like.

In one arrangement, one surface of the or each substrate is coated at least partially with an adhesive to enable it to be secured to an exposed lower surface of the stamping block. The adhesive may take the form of an adhesive pad covered by a removable mask. Alternatively the or each substrate may have one or more pieces of Velcro (registered trade mark) which cooperate with a similar piece or pieces of Velcro attached to the stamping surface. Other known means of attachment may be employed.

The lower surface of the stamping block may be flat, curvilinear or circular. Other shaped surfaces may be used.

The surface of the, one, some or each substrate may be scored or otherwise indented. Alternatively, or additionally, the surface of the, one, some or each substrate may be ridged or partially raised.

The source of colorant may comprise a fibrous tipped marker pen, a paint brush or other known applicator.

A colouring set in accordance with the invention may comprise a stamp having a stamping block with a lowersurface, a plurality of substrates as described in the preceding paragraphs, and a plurality of marker pens. The colouring set may also include a plurality of stencils. The stamp may be hand held.

In a further aspect the invention comprises a flexible image bearing impermeable substrate formed with a textured surface for attachment to a lower surface of a stamping block, the substrate comprising ethylene vinyl acetate.

The stamp may be hand held.

In a still further aspect, the invention comprises a stamp whose image transferring surface comprises an impermeable flexible substrate of a to polymer or copolymer material having a textured surface. The material preferably comprises ethylene vinyl acetate.

The invention will now be described, by way of example only, with reference to the accompanying drawings in which:

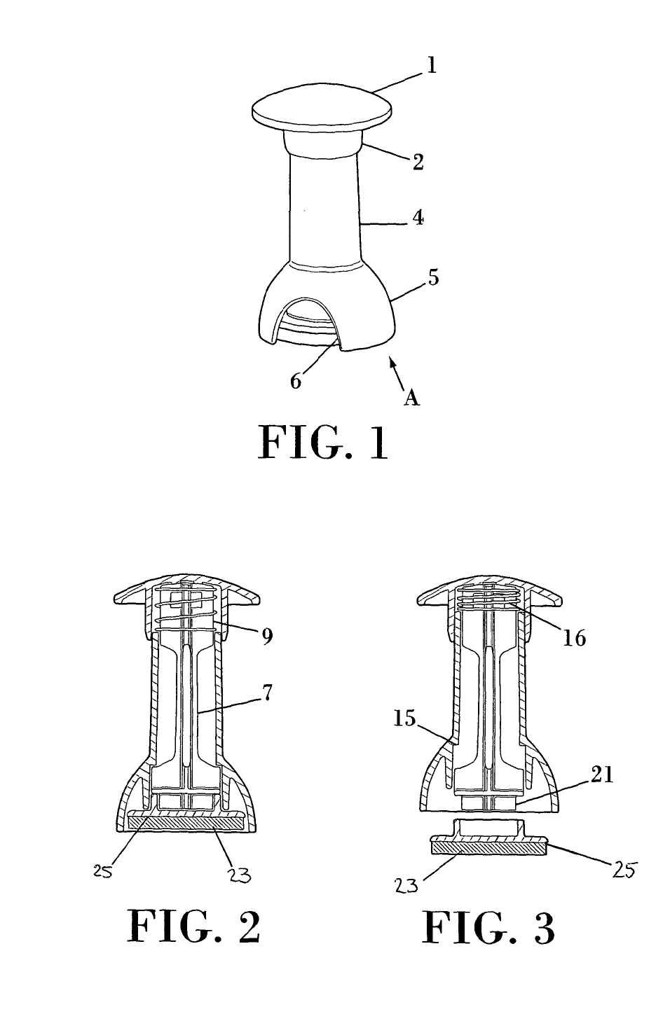

FIG. 1 is a side view of hand-held stamping apparatus in accordance with the invention;

FIGS. 2 and 3 are side views in section of the stamping apparatus shown in FIG. 1 in two operating positions;

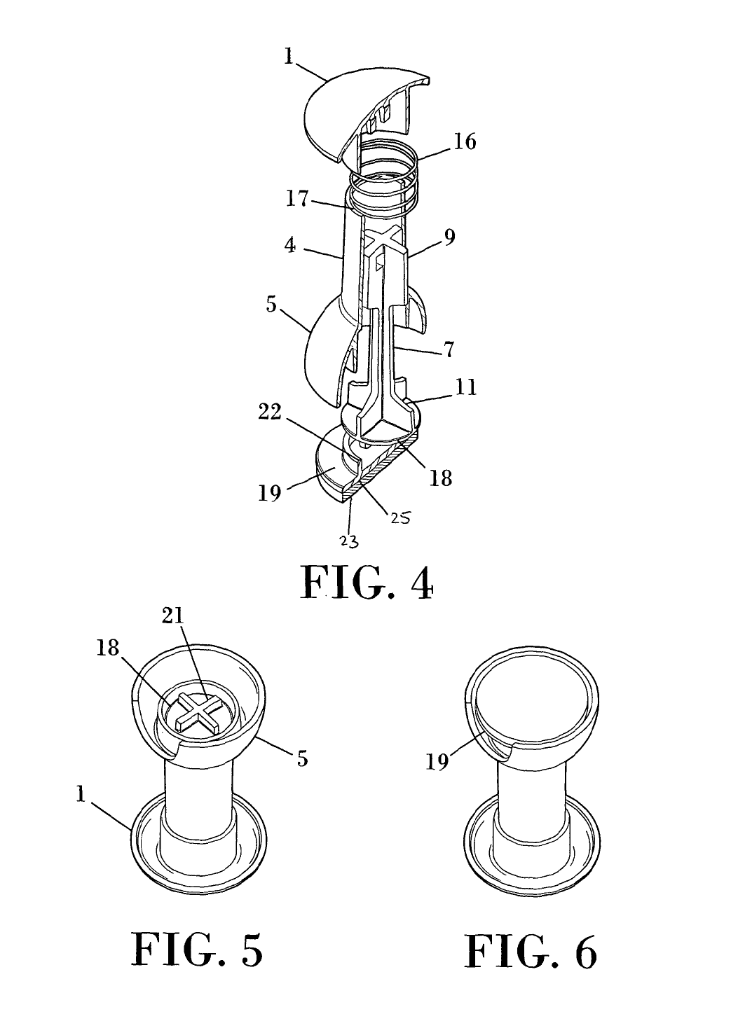

FIG. 4 is an exploded sectional view of the stamping apparatus illustrated in FIGS. 1 to 3;

FIGS. 5 and 6 are perspective views taken generally in the direction of arrow A of FIG. 1 showing the underside of the illustrated stamping device without and with a stamping block and substrate attached;

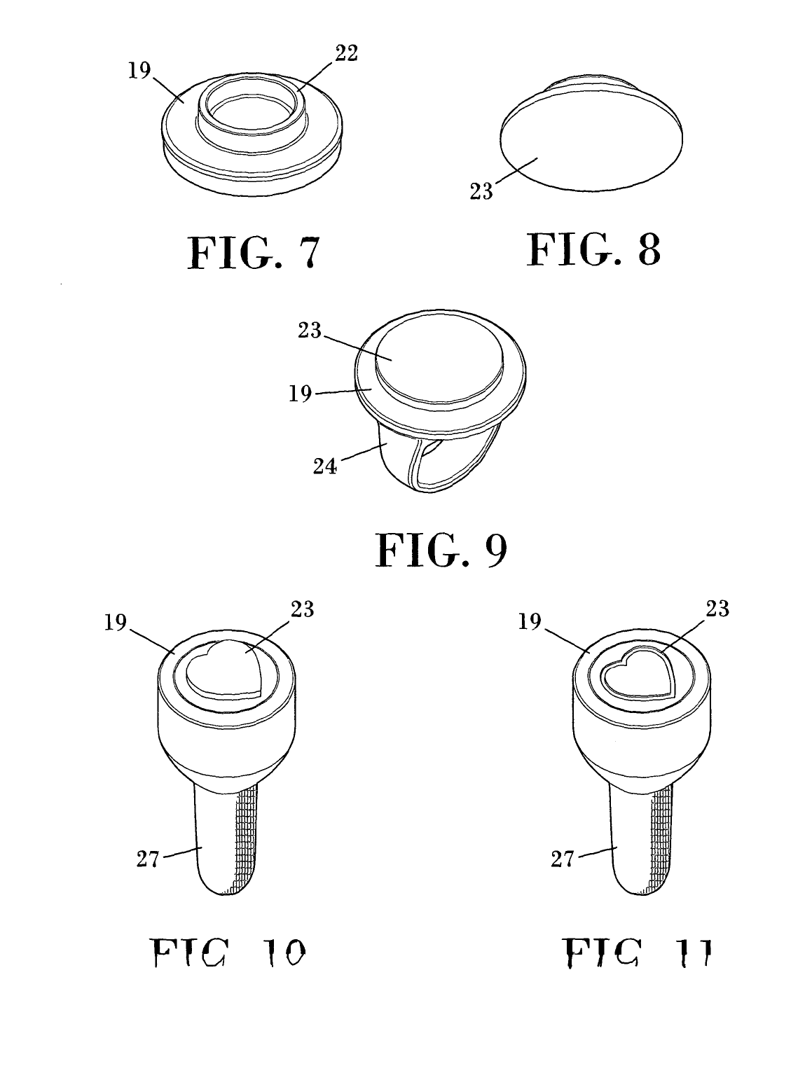

FIGS. 7 and 8 are perspective views of the upper and lower surfaces of the stamping block which forms part of the illustrated apparatus;

FIG. 9 is a perspective view of a ring shaped stamping apparatus in accordance with the invention;

FIGS. 10 and 11 are perspective views of alternative stamping apparatus in accordance with the invention;

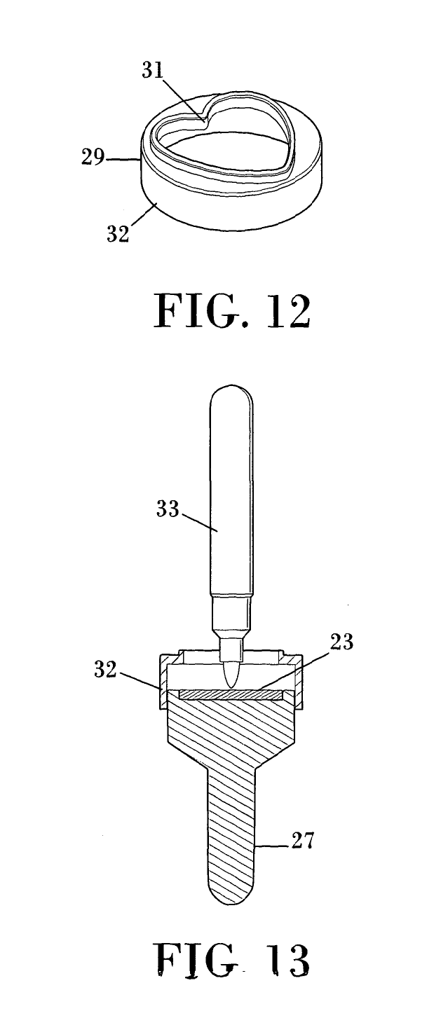

FIG. 12 is a perspective view of a stencil device for use with stamping apparatus in accordance with the invention; and

FIG. 13 shows the stencil device of FIG. 12 in use with a stamping apparatus in accordance with the invention.

The stamp illustrated in FIGS. 1 to 6 is a hand-operated stamp which includes a cap 1 formed with a collar 2 which locates over and defines a sliding fit with the upper open end of a sleeve 4. The open lower end 5 of the sleeve is flared and includes a side opening 6. In an alternative embodiment the side opening is not present.

Positioned for sliding movement within the sleeve 4 is a spindle 7.

The spindle has a central spine whose upper end is formed with outwardly extending arms 9 which locate the spindle centrally within the sleeve 4. The lower end of the spindle is formed with four outwardly extending arms 11 whose distal ends locate below a step 15 formed in the inner surface of the flared lower end 5 of the sleeve.

A coil spring 16 is positioned around the arms 9 with its upper end in contact with the underside of the cap 1 and its lower end seated on the upper rim 17 of the sleeve 4.

It will be appreciated that the above is one example of how the apparatus is constructed and that the apparatus may have an alternative construction.

The arms 11 of the spindle 7 are upstanding from a disc 18 whose under surface defines a holder for retaining a stamping block 19. As will be seen from FIG. 5, the disc 18 includes cross arms 21 dimensioned to define a friction fit within an annular ring 22 (see particularly FIG. 7) upstanding from the upper surface of the stamping block 19. The stamping block 19 has a lower surface 25 on which a flexible image transferring substrate 23 is located.

The lower surface 25 in this case is the underside of the stamping block 19 which, in the absence of the substrate, 23 would come into contact with the surface to be stamped during use.

As shown, the substrate 23 is formed integrally with the stamping block 19 and may comprise one of a plurality of such blocks, each being selectively connectable to the underside of the disc 18. Alternatively the substrate may be separable from the stamping block and may be connected to the lower surface of the block by, for example, an adhesive pad covered with a piece of removable masking tape. Alternative means for attaching the substrate to the stamping block may be adopted.

The image transferring substrate 23 is impermeable and preferably comprises a piece of ethylene vinyl acetate (EVA) shaped and sized to be secured to the lower surface of the stamping block 19The stamping surface of the substrate 23 is textured.

An alternative stamping apparatus in accordance with the invention is illustrated in FIG. 9. In this embodiment the apparatus takes the form of a ring 24 whose upper surface has affixed thereto, or aninset to receive, a suitably shaped stamping block 19 and substrate 23 of EVA or like material as described above.

As will be seen from FIG. 10 a suitably shaped substrate 23 may be attached to and stand proud from the lower surface of the stamping block 19. Alternatively as shown in FIG. 11 the stamping surface of substrate may be embossed with any required shape or pattern. In each of these embodiments, the stamping apparatus has a handle 27 depending from the stamping block 19 as can be seen in FIGS. 1 to 6.

FIGS. 12 and 13 illustrate a cap 29 used as a stencil when applying selected shapes onto the surface of substrates. The cap has an upper surface 31 formed with opening of the required shape and a lip 32 which fits over the upper end of the stamping apparatus. A coloured shape can then be drawn onto the exposed surface of the substrate using a conventional fibrous tipped marker pen 33 by simply following the contour of the shape.

Substrates produced from impermeable textured polymers or copolymers other than EVA may be employed.

In use, colorant is selectively applied to the textured surface 23 of the substrate by, for example, a conventional fibrous tipped marker pen, a paint brush or similar applicator. More than one colour may be applied to the substrate surface either randomly or as a pattern.

As mentioned, the colorant may be applied through suitably shaped stencils. Preferably, the ink or paint used is washable.

Once the substrate is secured to the lower surface of the stamping block, the image created on the stamping surface of the substrate can be transferred to any surface selected by the user, whether this is a sheet of drawing paper or some other medium.

Because of the textured impermeable nature of the EVA substrate the ink or paint applied to its surface remains wet for sufficient time to enable a user to apply ink or paint to the substrate surface to achieve a desired colour or multi-colour effect. Experiments conducted by the Applicant have established that the surface remains wet for fifteen minutes or more. Corrections to the applied colorant can readily be made by removing some or all of the ink or paint using a soft cloth or the like. Inks or paints of different colours may be applied to the same substrate surface. Experiments conducted by the Applicant have also established that the design is transferred from the stamping surface of the substrate to a sheet of paper or the like approximately four to five times before the image begins to degrade or lose intensity and ultimately the colorant needs to be replenished on the surface of the substrate.

Once the colorant has image to such an extent that no colorant is transferred to the sheet of paper, or the image is otherwise wiped from the substrate, the same or different colorant may be applied such that the stamping device can be used time and time again.

The stamping surface of the substrate may be patterned to enable coloured shapes to be produced consistently and transferred to a sheet of paper or the like. Thus, grooves, indentations and/or ridges in the shape of, for example, a flower or animal, may be formed in the substrate surface. Once coloured these images can be replicated by transferring them to, for example, a sheet of drawing paper. The grooves may be implanted into the substrate surface or may be created by the user employing a pointed relatively hard nib such as a ball point pen.

A colouring set in accordance with this invention may comprise a stamp as described, a plurality of polymeric substrates, a set of marker pens and a plurality of stencils.

More than one substrate may be applied to the lower surface of the stamping block. Thus, a plurality of relatively small substrates of the same shape or of different shapes may be simultaneously attached to the lower surface of the stamping block and then separately coloured. These shapes may comprise, for example, geometric shapes such as squares, circles, stars and rectangles; or reflected images of letters of the alphabet; or flower shapes; or indeed any other suitable shapes. Once coloured, dots or glitter particles or the like may be dispersed over the substrate surface for transfer with the image onto any required surface.

The colouring set may include a holder (not shown) for one or more stamps. The holder may include an angled recess or recesses in which the or each stamp can be retained. The recesses are shaped, dimensioned and angled to receive the capped end of the stamp, remote from the end holding the substrate, such that colourant can be applied to the stamping surface of the substrate whilst the stamp is retained within the holder.

It will be appreciated that the foregoing is merely exemplary of stamping apparatus for transferring personalised coloured patterns in accordance with the invention and that modifications may be made to the described apparatus without departing from the true scope of the invention. For example, the stamp need not be hand held. In such an arrangement, the stamp may be incorporated as part of a larger device which includes an operating mechanism capable of moving the substrate bearing stamping block into contact with an image receiving surface.

1. Stamping apparatus for transferring a personalised coloured image onto a selected surface, the apparatus comprising a stamp including a stamping block and a flexible image bearing impermeable substrate of a polymer or copolymer attachable to the stamping block, the image bearing surface of the substrate being textured.

2. Apparatus as claimed in claim 1 wherein the polymer or copolymer comprises ethylene vinyl acetate.

3. Stamping apparatus for transferring a personalised coloured image onto a selected surface, the apparatus comprising a stamping block with a lowersurface, an impermeable flexible substrate of a polymer or copolymer having an image bearing surface which is textured but otherwise plain, and a non image bearing surface, means for attaching the non image bearing surface of the substrate to the lower surface of the stamp, and means for applying a liquid colorant to the image bearing surface of the substrate.

4. Apparatus as claimed in claim 1 wherein the textured image bearing surface of the substrate is otherwise plain.

5. Apparatus as claimed in claim 3 wherein the polymer or copolymer is ethylene vinyl acetate.

6. A colouring set comprising a stamp including a lower surface, a flexible image bearing impermeable substrate of a polymer or copolymer formed with a textured surface for selective or permanent attachment to the lower surface, and a source for applying liquid colorant onto that surface of the substrate which will be exposed when the substrate is attached to the lower surface.

7. A colouring set as claimed in claim 6 wherein the textured surface of the substrate is otherwise plain.

8. A colouring set as claimed in claim 6 wherein the stamp includes a handle.

9. Apparatus as claimed in claim 1 wherein the substrate comprises a flat sheet in the shape of a rectangle, square, circle, ellipse or other regular or irregular shape.

10. A colouring set as claimed in claim 6 wherein the substrate comprises a flat sheet in the shape of a rectangle, square, circle, ellipse or other regular or irregular shape.

11. Apparatus or a colouring set as claim 1 wherein the substrate comprises one of a set of such substrates.

12. Apparatus or a colouring set as claimed in claim 1 wherein one surface of the substrate is coated with an adhesive to enable it to be secured to the stamping surface.

13. Apparatus or a colouring set as claimed in claim 12 wherein the adhesive comprises an adhesive pad covered by a removable mask.

14. Apparatus or a colouring set as claimed in claim 1 wherein one surface of the substrate is scored, indented or ridged.

15. Apparatus as claimed in claim 1 wherein the source of colorant comprises a fibrous tipped marker pen.

16. Apparatus as claimed in claim 3 wherein the liquid colorant applying means comprises a fibrous tipped marker pen.

17. A colouring set as claimed in claim 6 comprising a plurality of substrates and a plurality of fibrous tipped marker pens.

18. A colouring set as claimed in claim 6 further comprising at least one stencil.

19. A flexible image bearing impermeable substrate formed with a textured surface, wherein the substrate, in use, is attached to a lower surface of a stamp, and wherein the substrate comprises ethylene vinyl acetate.
